(19) United States
(12) Patent Application Publication
(10) Pub. No.: US 2025/0118876 A1
(43) Pub. Date: Apr. 10, 2025

(54) ALL-SOLID-STATE BATTERY ASSEMBLY

(71) Applicants: Hyundai Motor Company, Seoul (KR); Kia Corporation, Seoul (KR); UNIST (Ulsan National Insitute of Science and Technology), Ulsan (KR)

(72) Inventors: Ji Young Kim, Suwon (KR); Sam Ick Son, Suwon (KR); Ki Yoon Bae, Seoul (KR); Hyun Wook Lee, Ulsan (KR); Chan Hee Lee, Ulsan (KR)

(21) Appl. No.: 18/828,978

(22) Filed: Sep. 9, 2024

(30) Foreign Application Priority Data
Oct. 5, 2023 (KR) 10-2023-0132643

(51) Int. Cl. H01M 50/578; H01M 10/0587; H01M 10/42; H01M 10/48

(52) U.S. Cl. CPC H01M 50/578; H01M 10/0587; H01M 10/425; H01M 10/48

(57) ABSTRACT

Disclosed is an all-solid-state battery assembly including an all-solid-state battery configured such that a plurality of electrode layers and a plurality of solid-electrolyte layers are laminated in a lamination direction, a housing accommodating the all-solid-state battery, a pressure adjusting part that adjusts a pressure applied to the all-solid-state battery, and a displacement acquisition unit that measures, determines or acquires a change in a thickness of the all-solid-state battery in the lamination direction.

### CROSS-REFERENCE TO RELATED APPLICATION

This application claims the benefit of Korean Patent Application No. 10-2023-0132643, filed in the Korean Intellectual Property Office on Oct. 5, 2023, the entire contents of which are incorporated herein by reference.

### BACKGROUND

### Technical Field

The present disclosure relates to an all-solid-state battery assembly having a displacement acquisition unit to accurately assess the gradient of an internal constraining pressure that may occur due to volume changes while the all-solid-state battery is operating. By measuring local volume changes within the electrode in real time and based on this, the present invention relates to an auxiliary control device that can maintain a constant constraining pressure.

### Background

Unlike primary batteries, which cannot be recharged after discharge, secondary batteries, which may be reused through charging after discharge, may be applied to various fields such as smartphones, automobiles, drones, and robots, and their importance is increasing day by day.

As secondary batteries according to the existing technologies use liquid as an electrolyte, there is a problem of poor stability, such as explosion and fire when expansion due to temperature changes or leakage due to external shock occurs, and to solve these problems, research and development on all-solid-state batteries are being actively conducted.

The all-solid-state battery has high structural stability as an electrolyte located between positive and negative active material layers is formed of solid, and thus there is no need to provide safety-related items, such as separators, and the battery may be miniaturized and have high energy density. However, in the case of an all-solid-state battery, there are limitations such as expansion and contraction of the electrode active material during charging/discharging, and as a result, the interface between the electrode active material and the solid electrolyte is separated and performance is reduced.

### SUMMARY

The present disclosure has been made to solve the above-mentioned problems occurring in the existing technologies while advantages achieved by the existing technologies are maintained intact.

An embodiment of the present disclosure may provide an all-solid-state battery assembly that may control a constraining pressure of an all-solid-state battery.

An embodiment of the present disclosure may provide an all-solid-state battery assembly that may measure, determine or acquire a thickness displacement and a constraining pressure of an all-solid-state battery in real time, and may control the constraining pressure based on measured, determined or acquired data.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, an all-solid-state battery assembly includes an all-solid-state battery comprising a plurality of electrode layers and a plurality of solid-electrolyte layers laminated in a lamination direction, a housing accommodating the all-solid-state battery, a pressure adjusting part that adjusts a pressure applied to the all-solid-state battery, and a displacement acquisition unit that measures, determines or acquires a change in a thickness of the all-solid-state battery in the lamination direction.

The pressure adjusting part may comprise a constraining pad disposed in an interior of the housing, and overlapping the all-solid-state battery in the lamination direction to press the all-solid-state battery, and at least one driving unit disposed to be spaced apart from the all-solid-state battery, and connected to the constraining pad to control a pressure applied to the all-solid-state battery by the constraining pad.

The displacement acquisition unit may contact one surface of the all-solid-state battery on an outermost side in the lamination direction, and may measure, determine or acquire the change in the thickness of the all-solid-state battery by measuring a distance, by which the one surface of the all-solid-state battery is moved along the lamination direction.

The displacement acquisition unit may contact one surface of the all-solid-state battery, which contacts the constraining pad.

The displacement acquisition unit may pass through the constraining pad to contact one surface of the all-solid-state battery, which contacts the constraining pad.

The displacement acquisition unit may include a first displacement acquisition unit and a second displacement acquisition unit disposed to be spaced apart from each other.

The displacement acquisition unit may include a first displacement acquisition unit and a second displacement acquisition unit located at the same distance from a central axis passing through a center of the all-solid-state battery in the lamination direction.

The driving unit may adjust a distance between one inner surface of the housing, which overlaps the all-solid-state battery in the lamination direction, and supports the all-solid-state battery when being pressed by the constraining pad, and the constraining pad disposed to be spaced apart from the one inner surface in the lamination direction.

The constraining pad may overlap the all-solid-state battery in the lamination direction, and may be disposed to be spaced apart from one inner surface of the housing, which supports the all-solid-state battery when being pressed by the constraining pad, in the lamination direction.

The driving unit may be located between one inner surface of the housing, which supports the all-solid-state battery when being pressed by the constraining pad, and the constraining pad, to control a pressure applied to the all-solid-state battery by the constraining pad through a change in a length thereof in a state, in which the one inner surface and the constraining pad are connected to each other.

The at least one driving unit may be a pair of driving units, and the pair of driving units may be provided on one side and an opposite side of the all-solid-state battery.

The driving unit may include a fixing part protruding from one inner surface that supports the all-solid-state battery when being pressed by the constraining pad, in the lamination direction, a coupling part coupled to the fixing part to be moved relative to the fixing part in the lamination direction, and a driving part connected to the coupling part, and that drives the coupling part such that the coupling part is moved with respect to the fixing part.

The all-solid-state battery assembly may further include a pressure acquisition unit overlapping the all-solid-state battery in the lamination direction, and that measures, determines or acquires a magnitude of a pressure applied to the all-solid-state battery in the lamination direction.

The all-solid-state battery assembly may further include a pressure acquisition unit disposed between one inner surface of the housing, which supports the all-solid-state battery when being pressed by the constraining pad, and the all-solid-state battery.

The all-solid-state battery assembly may further include a processor that controls driving of the driving unit based on a change in the thickness of the all-solid-state battery in the lamination direction, which is measured, determined or acquired by the displacement acquisition unit.

The processor may control driving of the driving unit based on a difference value between a preset initial thickness of the all-solid-state battery and the measured thickness of the all-solid-state battery.

The processor may control such that the driving unit is driven when a ratio of the difference value to the initial thickness is more than a preset indicator value.

The processor may control a driving direction of the driving unit such that a pressure applied to the all-solid-state battery decreases when the ratio of the difference value to the initial thickness is more than the preset indicator value and the measured thickness of the all-solid-state battery is smaller than the initial thickness.

The processor may control a driving direction of the driving unit such that a pressure applied to the all-solid-state battery increases when the ratio of the difference value to the initial thickness is more than the preset indicator value and the measured thickness of the all-solid-state battery is larger than the initial thickness.

The all-solid-state battery assembly may further include a processor that drives the driving unit based on the change in the thickness of the all-solid-state battery in the lamination direction, which is measured, determined or acquired by the displacement acquisition unit, and the pressure of the all-solid-state battery, which is measured, determined or acquired by the pressure acquisition unit.

The processor may control driving of the driving unit based on a differenced value between a preset initial thickness of the all-solid-state battery and the measured thickness of the all-solid-state battery, and may readjust the driving of the driving unit by identifying a pressure of the all-solid-state battery caused by the driving of the driving unit.

Also provided is a vehicle including the all-solid-state battery as described herein.

Other aspects are disclosed infra.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a housing of an all-solid-state battery assembly according to an exemplary embodiment of the present disclosure;

FIG. 2 is a schematic view illustrating an internal structure of a housing of an all-solid-state battery assembly, viewed in a direction that is perpendicular to a lamination direction, according to an exemplary embodiment of the present disclosure;

FIG. 3 is a schematic view of an internal structure of a housing of an all-solid-state battery assembly, when viewed in a lamination direction, according to an exemplary embodiment of the present disclosure;

FIGS. 4 and 5 are schematic views illustrating a driving scheme of a driving unit of an all-solid-state battery assembly according to an exemplary embodiment of the present disclosure;

FIG. 6 is a schematic view illustrating a driving scheme of an all-solid-state battery assembly according to another embodiment of the present disclosure;

FIG. 7 is a circuit diagram conceptually illustrating an all-solid-state battery assembly according to an exemplary embodiment of the present disclosure; and

FIG. 8 is a flowchart illustrating a process of controlling an all-solid-state battery assembly according to an exemplary embodiment of the present disclosure.

### DETAILED DESCRIPTION

Hereinafter, preferred embodiments of the present disclosure will be described in detail with reference to the attached drawings so that those skilled in the art may easily implement the present disclosure. The following description is one of several embodiments of the embodiments, and in describing one embodiment, detailed descriptions of known functions or configurations are omitted to clarify the gist of the present disclosure.

When adding reference numerals to components in each drawing in this specification, identical or similar reference numerals are used for identical or similar components throughout the specification. Components included in one embodiment and components including common functions will be described using the same names in other embodiments. Terms or words used in this specification and claims should not be construed as limited to their ordinary or dictionary meanings, and have to be interpreted with meaning and concept consistent with the technical idea of the present disclosure, based on the principle that the inventor has to appropriately define the concept of terms in order to describe his or her invention in the best way.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

A term “all-solid-state battery” as used herein refers may include a rechargeable secondary battery that includes an electrolyte in a solid state, e.g., gel or polymer (cured) or solid material, which may include an ionomer and other electrolytic components for transferring ions between the electrodes of the battery.

In addition, the present disclosure is not limited to the above-described embodiments, and various modifications and variations may be made from these descriptions by those with ordinary knowledge in the field, to which the present disclosure belongs. Therefore, the idea of the present disclosure should not be limited to the above-described embodiments, and the scope of the patent claims described later as well as all things that are equivalent or equivalent to the scope of the patent claims are said to fall within the scope of the idea of the present disclosure.

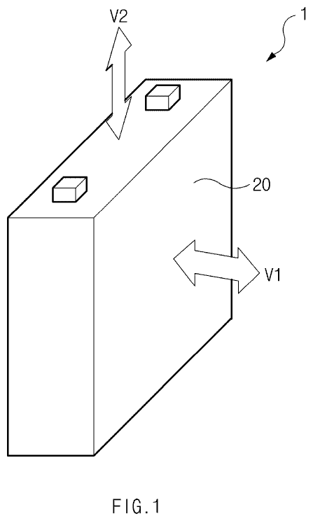

FIGS. 1 to 3 illustrate a structure of an all-solid-state battery assembly 1 according to an exemplary embodiment of the present disclosure.

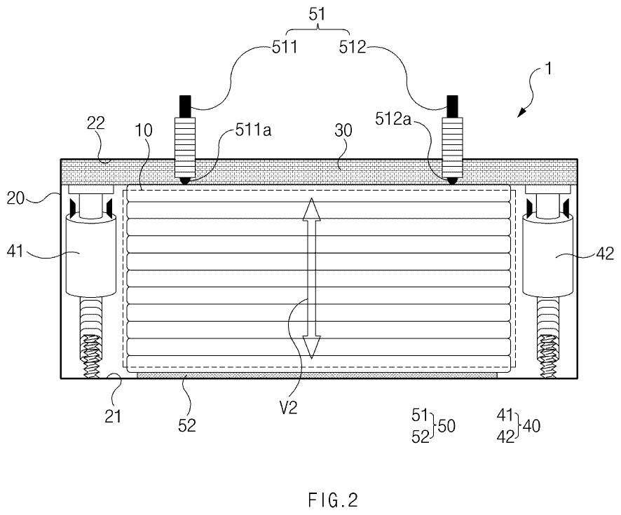

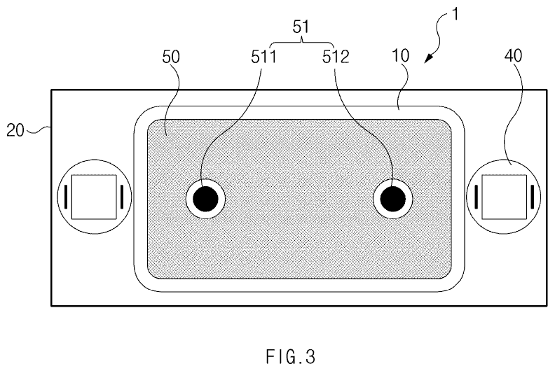

FIG. 1 is a perspective view illustrating a housing 20 of the all-solid-state battery assembly 1 according to an exemplary embodiment of the present disclosure, FIG. 2 is a schematic view illustrating an internal structure of the housing 20 of the all-solid-state battery assembly 1, viewed in a direction that is perpendicular to a lamination direction, according to an exemplary embodiment of the present disclosure, and FIG. 3 is a schematic view of the internal structure of the housing 20 of the all-solid-state battery assembly 1, when viewed in another direction, according to an exemplary embodiment of the present disclosure. In detail, FIG. 2 is a view illustrating a shape of the internal structure of the housing 20, when viewed in a first direction v1 that is perpendicular to a lamination direction of the electrode assembly, and FIG. 3 is a schematic view illustrating the internal structure of the housing 20 of the all-solid-state battery assembly 1, viewed in a second direction v2 that is the lamination direction of the electrode assembly, according to an exemplary embodiment of the present disclosure (see FIG. 1). However, in FIG. 3, it is noted that a shape of a constraining pad 30 is omitted for understanding of the internal structure. Furthermore, FIGS. 2 and 3 are schematic views conceptually illustrating components disposed in an interior of the housing 20, and it is noted that shapes or disposition structure of the components are not directly limited to the illustration.

Structure of all-Solid-State Battery Assembly 1

Referring to FIG. 2, the all-solid-state battery assembly 1 according to an exemplary embodiment of the present disclosure may include an all-solid-state battery 10, the housing 20, pressure adjusting parts 30 and 40, and a displacement acquisition unit 51.

The all-solid-state battery 10 may be formed by stacking a plurality of electrode assemblies 11, and each of the electrode assemblies 11 may include a positive electrode layer, a negative electrode layer, and a solid-electrolyte layer. For example, the electrode assembly 11 may be one assembly unit body that constitutes the all-solid-state battery 10 and in which the positive electrode layer, the solid-electrolyte layer, the negative electrode layer, and the solid-electrolyte layer are sequentially laminated.

The housing 20 may be configured to accommodate the all-solid-state battery 10 that is formed by stacking the electrode assembly 11. The housing 20 may function as a frame that supports the all-solid-state battery 10 to maintain a shape of the all-solid-state battery 10 by accommodating the all-solid-state battery 10. The housing 20, for example, may be provided in the form of a square case that surrounds the all-solid-state battery 10.

The plurality of electrode assemblies 11 of the all-solid-state battery 10 may be stacked in a direction from one inner surface 21 toward an opposite inner surface 22 of the housing 20, and the one inner surface 21 and the opposite inner surface 22 of the housing 20 may be surfaces that are opposite to each other. The one inner surface 21 of the housing 20 may be a surface that supports the all-solid-state battery 10 when being pressed by the constraining pad 30. Areas of the one inner surface 21 and the opposite inner surface 22 of the housing 20 may be larger than an area of the electrode assembly 11 of the all-solid-state battery 10. For example, the all-solid-state battery 10 may be disposed to be positioned at a central portion of the one inner surface 21 and the opposite inner surface 22 of the housing 20.

The pressure adjusting parts 30 and 40 may include the constraining pad 30 and the driving unit 40.

The constraining pad 30 may be configured to press the plurality of electrode assemblies 11 of the all-solid-state battery 10. The constraining pad 30 may be disposed in an interior of the housing 20. The constraining pad 30 may be disposed to overlap the all-solid-state battery 10. The constraining pad 30 may be configured to cover the plurality of electrode assemblies 11 of the all-solid-state battery 10, and may have an area that is larger than that of the electrode assembly 11. The constraining pad 30, for example, may have a size corresponding to an inner surface of the housing 20.

One surface of the constraining pad 30 may face one surface of the all-solid-state battery 10, and an opposite surface of the constraining pad 30 may contact the opposite inner surface 22 of the housing 20. In other words, the plurality of electrode assemblies 11 of the all-solid-state battery 10 and the constraining pads 30 may be sequentially stacked in a direction from the one inner surface 21 toward the opposite inner surface 22 of the housing 20.

Pressure of all-Solid-State Battery 10

The plurality of electrode assemblies 11 of the all-solid-state battery 10 may be pressed between the one inner surface 21 of the housing 20 and the constraining pad 30. That is, the one inner surface 21 of the housing 20 and the constraining pad 30 may provide a constraining pressure to the all-solid-state battery 10 therebetween. Here, the constraining pressure may mean a pressure that is applied to the electrode assemblies 11 in the lamination direction of the plurality of electrode assemblies 11 of the all-solid-state battery 10.

Then, the constraining pressure applied to the all-solid-state battery 10 may increase when a distance between the constraining pad 30 and the one inner surface 21 of the housing 20 decreases, and the constraining pressure applied to the all-solid-state battery 10 may decrease when the distance between the constraining pad 30 and the one inner surface 21 of the housing 20 increases. The distance between the constraining pad 30 and the one inner surface 21 of the housing 20 may be adjusted by the driving unit 40.

### Driving Unit 40

The driving unit 40 may be configured to control a constraining pressure applied to the all-solid-state battery 10 by the constraining pad 30. The driving unit 40 may be provided in an interior of the housing 20. The driving unit 40 may be provided in an interior of the housing 20, and may be disposed to be spaced apart from the all-solid-state battery 10 by a specific distance.

The driving unit 40 may be connected to the constraining pad 30. The driving unit 40 may be connected to the one inner surface 21 of the housing 20. The driving unit 40 may connect the constraining pad 30 and the one inner surface 21 of the housing 20. The driving unit 40 may extend between the one inner surface 21 of the housing 20 and the constraining pad 30.

The driving unit 40 may be configured such that a length thereof is changeable. A length of the driving unit 40 between the one inner surface 21 of the housing 20 and the constraining pad 30 may be changed whereby a distance between the one inner surface 21 of the housing 20 and the constraining pad 30 may be adjusted, and thus, the constraining pressure applied to the all-solid-state battery 10 may be controlled.

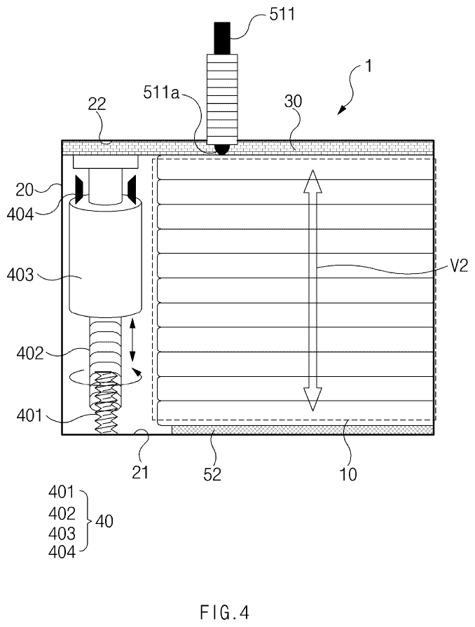

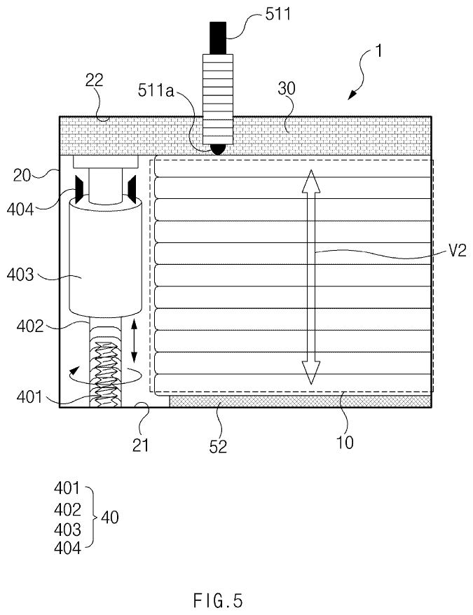

For example, the constraining pressure applied to the all-solid-state battery 10 may increase as the distance between the one inner surface 21 of the housing 20 and the constraining pad 30 becomes smaller when the length of the driving unit 40 becomes shorter, and the constraining pressure applied to the all-solid-state battery 10 may decrease as the distance between the one inner surface 21 of the housing 20 and the constraining pad 30 becomes larger when the length of the driving unit 40 becomes larger. A driving mechanism of the driving unit 40 will be described in detail with reference to FIGS. 4 and 5 that will be described later.

A plurality of driving units 40 may be provided. The driving units 40, for example, may be a pair of driving units provided on opposite sides of the all-solid-state battery 10. The driving units 40 may include a first driving unit 41 that is disposed on one side of the all-solid-state battery 10, and a second driving unit 42 that is disposed on an opposite side of the all-solid-state battery 10. The first driving unit 41 and the second driving unit 42 may be controlled to have the same length to apply a uniform constraining pressure to the electrode assembly 11 of the all-solid-state battery 10.

However, the number and the disposition form of the driving units 40 are not limited thereto, and if necessary, a larger number of driving units 40 may be provided around the all-solid-state battery 10.

### Displacement Acquisition Unit 51

The displacement acquisition unit 51 may be configured to measure, determine or acquire a change in the thickness of the all-solid-state battery 10 in the lamination direction, that is, a displacement of the all-solid-state battery 10 in the lamination direction.

The displacement acquisition unit 51 may measure, determine or acquire a change in the thickness of the all-solid-state battery 10 between the one inner surface 21 of the housing 20 and the constraining pad 30 in real time, and may be electrically connected to the processor that will be described later to provide pressure data that are bases for control of the driving unit 40.

The displacement acquisition unit 51 may contact one surface of the all-solid-state battery 10 on an outermost side in the lamination direction. In detail, the displacement acquisition unit 51 may contact the one surface of the all-solid-state battery 10, which contacts the constraining pad 30. As the displacement acquisition unit 51 may contact the one surface of the all-solid-state battery 10, which contacts the constraining pad 30 and thus, as the thickness of the all-solid-state battery 10 is changed, a distance, by which the one surface of the all-solid-state battery 10 is moved in the lamination direction, may be measured, and through this, the change in the thickness of the all-solid-state battery 10, that is, the displacement may be measured, determined or acquired.

The displacement acquisition unit 51, for example, may be a contact type displacement sensor. The displacement acquisition unit 51 may include a first displacement acquisition unit 511 and a second displacement acquisition unit 512. The first displacement acquisition unit 511 and the second displacement acquisition unit 512 may be disposed to be spaced apart from each other, and may be disposed to be symmetrical to each other with respect to a direction that is perpendicular to the lamination direction. That is, the first displacement acquisition unit 511 and the second displacement acquisition unit 512 may be located at the same distance from an imaginary central axis that passes the center of the all-solid-state battery 10 in the lamination direction. The first displacement acquisition unit 511 may be located on a side of the first driving unit 41, and the second displacement acquisition unit 512 may be located on a side of the second driving unit 42. In some embodiments, the displacement acquisition unit 51 may include more than two displacement acquisition units.

As described above, the first displacement acquisition unit 511 and the second displacement acquisition unit 512 may be contact type displacement sensors. To achieve this, the first displacement acquisition unit 511 and the second displacement acquisition unit 512 may include contact tips 511a and 512a that contact one surface of the all-solid-state battery 10. The contact tip 511a of the first displacement acquisition unit and the contact tip 512a of the second displacement acquisition unit may contact the one surface of the all-solid-state battery 10, which contacts the constraining pad 30, to sense a movement distance of the one surface of the all-solid-state battery 10 in the lamination direction as the thickness of the all-solid-state battery 10 is changed. Through this, a displacement of the thickness of the all-solid-state battery 10 may be measured, determined or acquired.

Because the first displacement acquisition unit 511 and the second displacement acquisition unit 512 are disposed to be symmetrical to each other with respect to the direction that is perpendicular to the lamination direction, and the displacements of thickness in the respective directions may be independently measured, determined or acquired and the changes in the thicknesses of the first driving unit 41 and the second driving unit 42 may be independently controlled when the thickness of the all-solid-state battery 10 is unbalanced with respect to the direction (for example, the leftward/rightward direction) that is perpendicular to the lamination direction. For example, when the displacement on the left side is small, and the displacement on the right side is greater than the displacement during normal behavior, it can be understood that charging and discharging are intensively occurring at the electrode interface on the right side. To ensure normal behavior, it is necessary to increase the constraining pressure in the left area with less displacement, and decrease the constraining pressure in the right area.

The displacement acquisition unit 51 may be formed to pass through the constraining pad 30 to contact the one surface of the all-solid-state battery 10, which contacts the constraining pad 30. However, unlike this, the displacement acquisition unit 51 may not be the contact type displacement sensor but a laser displacement sensor, and the form and the location of the displacement acquisition unit 51 is not directly limited to the illustration.

The all-solid-state battery assembly 1 according to an exemplary embodiment of the present disclosure may further include a pressure acquisition unit 52. Here, the pressure acquisition unit 52 and the above-described displacement acquisition unit 51 may be comprehensively referred to as a data acquisition unit 50.

### Pressure Acquisition Unit 52

The pressure acquisition unit 52 may be configured to measure, determine or acquire the constraining pressure of the all-solid-state battery 10. The pressure acquisition unit 52 may be configured to be stacked on the all-solid-state battery 10. The pressure acquisition unit 52 may overlap the all-solid-state battery 10 in the form of a flat panel, and for example, may be a pressure sensor.

The pressure acquisition unit 52 may be stacked between the one inner surface 21 of the housing 20 and the all-solid-state battery 10. Accordingly, the pressure acquisition unit 52, the all-solid-state battery 10, and the constraining pad 30 may be sequentially stacked in a direction from the one inner surface 21 toward the opposite inner surface 22 of the housing 20.

The pressure acquisition unit 52 may measure, determine or acquire the constraining pressure of the all-solid-state battery 10 between the one inner surface 21 of the housing 20 and the constraining pad 30 in real time, and like the displacement acquisition unit 51, may be electrically connected to the processor that will be described later to provide pressure data that are bases for control of the driving unit 40.

### Driving Principle of Driving Unit 40

FIGS. 4 and 5 are schematic views illustrating a driving scheme of the driving unit 40 of the all-solid-state battery assembly 1 according to an exemplary embodiment of the present disclosure. FIG. 4 illustrates driving of the driving unit 40 for increasing the constraining pressure of the all-solid-state battery 10, and FIG. 5 illustrates driving of the driving unit 40 for decreasing the constraining pressure of the all-solid-state battery 10.

Referring to FIGS. 4 and 5, the all-solid-state battery assembly 1 according to an exemplary embodiment of the present disclosure may include a fixing part 401, a coupling part 402, and a driving part 403.

The fixing part 401 may be formed on the one inner surface 21 of the housing 20. The fixing part 401 may protrude from the one inner surface 21 of the housing 20. The fixing part 401, for example, may be fixed to the one inner surface 21 of the housing 20 in the form of a screw bolt having a specific length. Then, a lengthwise direction of the fixing part 401 may be the lamination direction of the electrode assembly 11 of the all-solid-state battery 10.

The coupling part 402 may be coupled to be movable relative to the fixing part 401. For example, the coupling part 402 may be coupled to be rotatable with respect to the fixing part 401. The coupling part 402 may be in the form of a nut that is coupled to the fixing part 401 provided in the form of a screw bolt to be rotatable. That is, the coupling part 402 may include a screw thread, with which the fixing part 401 may be engaged, on an inner surface thereof. The coupling part 402 provided in the form of a nut may be moved in a lengthwise direction of the fixing part 401 while being rotated with respect to the fixing part 401. When the coupling part 402 is moved relative to the fixing part 401, the length of the driving unit 40 may be changed.

The driving part 403 may be connected to the coupling part 402 to drive the coupling part 402 such that the coupling part 402 is moved with respect to the fixing part. For example, as described above, when the fixing part 401 and the coupling part 402 are provided in the form of a bolt and a nut and are driven in a screw scheme, the driving part 403 may be configured to rotate the coupling part 402. Then, the driving part 403, for example, may be a rotary motor that is electrically driven.

The driving unit 40 may further include a terminal part 404.

The terminal part 404 may be formed in the driving part 403, and may supply external electric power to the driving part 403 such that the driving part 403 drives the coupling part 402. The terminal part 404, for example, may be provided in the form of an electrode.

The driving part 403 may be fixed to the constraining pad 30. The constraining pad 30, as described above, may be in contact with the opposite inner surface 22 of the housing 20. The constraining pad 30, for example, may be formed of an elastically deformable material. Accordingly, when the driving part 403 rotates the coupling part 402 and the coupling part 402 is moved along a lengthwise direction of the fixing part 401, the thickness of the constraining pad 30 may be changed correspondingly. Because the distance between the one inner surface 21 and the opposite inner surface 22 of the housing 20 is fixed, the thickness of the constraining pad 30 may decrease when the driving part 403 rotates the coupling part 402 and thus the length of the driving unit 40 increases, and to the contrary, the thickness of the constraining pad 30 may increase when the length of the driving unit 40 decreases.

The length of the driving unit 40 may increase when the coupling part 402 is rotated in one direction by the driving part 403, and the length of the driving unit 40 may decrease when the coupling part 402 is rotated in an opposite direction. The distance between the constraining pad 30 and the one inner surface 21 of the housing 20 may be changed in a process of increasing and decreasing the length of the driving unit 40, and accordingly, the constraining pressure of the all-solid-state battery 10, in which the plurality of electrode assemblies 11 are stacked, may be controlled.

In this process, the displacement acquisition unit 51 may measure, determine or acquire the change in the thickness of the all-solid-state battery 10 and the pressure acquisition unit 52 may measure, determine or acquire the constraining pressure of the all-solid-state battery 10, and here, the acquisition may comprehensively mean a process of sensing the thickness/pressure of the all-solid-state battery 10 or calculating and deriving the thickness/pressure of the all-solid-state battery 10 based on the sensed data.

### Another Embodiment (Movable Constraining Pad)

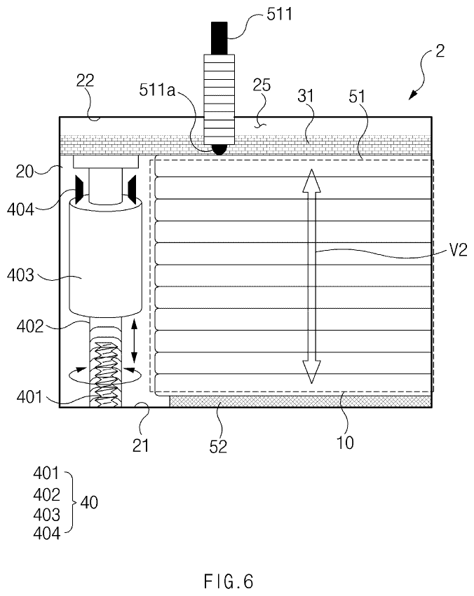

FIG. 6 is a schematic view illustrating the driving scheme of an all-solid-state battery assembly 2 according to another embodiment of the present disclosure.

The all-solid-state battery assembly 2 according to the second embodiment of the present disclosure may differ from the above-described embodiment in that the thickness of the constraining pad 30 may not be deformed. The contents that are common with those of the above-described embodiment will be omitted, and a difference therebetween will be mainly described with reference to FIG. 6.

Referring to FIG. 6, in the all-solid-state battery assembly 2 according to the second embodiment of the present disclosure, the length of the driving unit 40 may increase when the coupling part 402 is rotated in one direction by the driving part 403, and the length of the driving unit 40 may decrease when the coupling part 402 is rotated in an opposite direction. In the process of increasing and decreasing the length of the driving unit 40, the distance between a constraining pad 31 and the one inner surface 21 of the housing 20 may be changed, and accordingly, the constraining pressure of the all-solid-state battery 10, in which the plurality of electrode assemblies 11 are stacked, may be controlled.

Then, the constraining pad 31 may be moved in the lamination direction of the electrode assembly 11 as the length of the driving unit 40 increases and decreases. Then, the lamination direction, in which the constraining pad 31 is moved, may refer to both directions of a direction from the constraining pad 31 toward the one inner surface 21 of the housing 20 and a direction from the constraining pad 31 toward the opposite inner surface 22 of the housing 20. For example, when the length of the driving unit 40 decreases, the constraining pad 31 in contact with the opposite inner surface 22 of the housing 20 may be moved in a direction, in which the length of the driving unit 40 decreases, to be spaced apart from the opposite inner surface 22 of the housing 20, and in this case, a spaced apart 25 may be generated between the constraining pad 31 and the opposite inner surface 22 of the housing 20.

In other words, as in the above-described embodiment, even though the constraining pad is formed of an elastic material and the thickness thereof is not deformed, the constraining pressure of the all-solid-state battery 10 may be controlled while the constraining pad 31 is moved in the lamination direction of the electrode assembly 11 according to the driving of the driving unit 40.

Structure for Controlling All-solid-state Battery Assembly

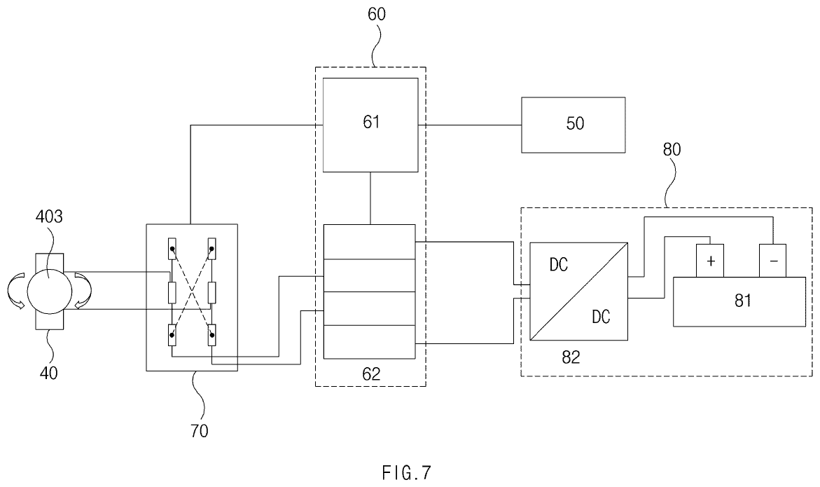

FIG. 7 is a circuit diagram conceptually illustrating an all-solid-state battery assembly according to an exemplary embodiment of the present disclosure.

Referring to FIG. 7, the all-solid-state battery assembly according to an exemplary embodiment of the present disclosure may further include a processor 60, a switch unit 70, and a power source unit 80.

The processor 60 may control driving of the driving unit 40 based on the thickness/pressure of the all-solid-state battery, which is measured, determined or acquired by the data acquisition unit 50 in real time. The processor 60 may include an ECU 61 and a current controller 62.

The ECU 61 and the current controller 62 may be electrically/physically connected to each other. The ECU 61 is an electronic control unit, and may be connected to the pressure acquisition unit 52 to receive the measured, determined or acquired pressure, and may compute it and deliver it to the current controller 62. In other words, the ECU 61 may adjust an amount of currents that are necessary for the current controller 62 and a signal may be input thereto. Furthermore, the ECU 61 may be connected to the switch unit 70 that will be described later and a signal regarding a rotational direction of the driving part 403 may be input to the switch unit 70.

The current controller 62 may receive a current from the power source unit 80, and may be connected to the ECU 61 to receive a signal from the ECU 61. The power source unit 80, as will be described later, may be configured to include the all-solid-state battery 10. The current controller 62 may receive a current from the power source unit 80, and may properly control an amount of currents supplied to the driving part 403 based on the signal received from the ECU 61.

The switch unit 70 may be disposed between the processor 60 and the driving unit 40. The switch unit 70 may be configured to adjust a rotational direction of the driving part 403 of the driving unit 40. The switch unit 70, for example, is a 6-pin switch, and may perform a control such that the driving part 403 provided in the form of a motor is rotated forwardly or reversely. The switch unit 70 may receive a forward/reverse rotation signal from the ECU 61 of the processor 60, and may receive the controlled amount of currents from the current controller 62 of the processor 60 and deliver the currents the driving part 403 of the driving unit 40.

The power source unit 80 may include a battery 81 and a converter 82. The battery 81 may be configured to supply electric power, and the converter 82 may be a DC-DC converter. Preferably, the battery 81 may be the above-described all-solid-state battery 10 that is accommodated in the housing 20. In other words, the driving unit 40 of the all-solid-state battery assembly according to an exemplary embodiment may receive electric power from not a separate external power source but the all-solid-state battery 10 itself in the housing 20 to be driven.

Algorithm for Controlling Pressure of all-Solid-State Battery

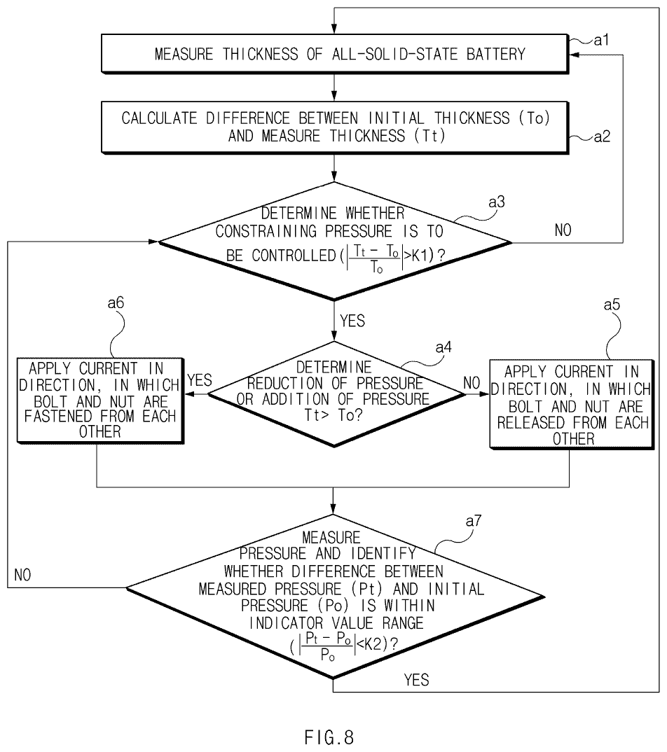

FIG. 8 is a flowchart illustrating a process of controlling an all-solid-state battery assembly according to an exemplary embodiment of the present disclosure.

Referring to FIG. 8, the constraining pressure of the all-solid-state battery of the all-solid-state battery assembly according to an exemplary embodiment of the present disclosure may be controlled by sequentially performing a thickness measuring operation a1, a thickness difference calculating operation a2, determination operations a3 and a4, and control operations a5 and a6, and a pressure identifying operation a7.

In the thickness measuring operation a1, the thickness of the all-solid-state battery may be measured, and, for example, the changed thickness of the all-solid-state battery in a charging/discharging process may be measured in real time.

Thereafter, in the thickness difference calculating operation a2, a difference value between the preset initial thickness of the all-solid-state battery and the thickness measured in real time may be calculated, and in the determination operations a3 and a4, whether the constraining pressure is to be controlled and a control method for the constraining pressure may be determined.

The determination operations a3 and a4 may include the constraining pressure control determining operation a3 and a constraining pressure control direction determining operation a4.

In the constraining pressure control determining operation a3, it may be determined whether it is necessary to control the pressure through a preset thickness indicator value

$$K 1 ( \vert \frac{Tt - T 0}{T 0} \vert ) .$$

The preset thickness indicator value K1 may be differently set depending on the sizes and kinds of various all-solid-state battery. K1 may also differ depending on the state of charge (SOC) of the battery. In some embodiments, K1 may be 0.1, In the constraining pressure control determining operation a3, a thickness TO of the all-solid-state battery, which is preset at the initial stage, and a measured thickness Tt of the all-solid-state battery may be compared, and for example, the difference value between the two may be converted into an index value to determine whether the difference value is more than the preset thickness indicator value K1.

Through this, when it is determined that the difference between the thickness TO of the all-solid-state battery, which is preset at the initial stage, and the measured thickness Tt of the all-solid-state battery is a reference value or more, the constraining pressure control direction determining operation a4 may be performed to determine whether the pressure is to be added or reduced (an increase or a decrease of the constraining pressure). When it is determined that the difference between the initial thickness TO of the all-solid-state battery and the measured thickness Tt of the all-solid-state battery is the reference range or less, the constraining pressure measuring operation a1 of the all-solid-state battery, which is changed in real time, may be performed again.

In the constraining pressure control direction determining operation a4, it may be measured whether the measured thickness Tt of the all-solid-state battery is larger than or smaller than the initial thickness TO of the all-solid-state battery, and through this, it may be determined, among the control operations a5 and a6, which of the pressure reducing operation a5 or the pressure adding operation a6 is to be performed. When the measured thickness Tt of the all-solid-state battery is more than the initial thickness TO of the all-solid-state battery, it may proceed to the pressure adding operation a6 in which the bolt and the nut may be fastened to each other and the constraining pressure may increase, and when the measured thickness Tt of the all-solid-state battery is less than the initial thickness TO of the all-solid-state battery, it may proceed to the pressure reducing operation a5 in which the bolt and the nut may be released from each other and the constraining pressure may decrease.

In other words, the control operations a5 and a6 may be performed based on the determination performed in the constraining pressure control direction determining operation a4. In the control operations, the pressure adding operation a6 of increasing the constraining pressure of the all-solid-state battery by decreasing the length of the driving unit or the pressure reducing operation a5 of decreasing the constraining pressure of the all-solid-state battery by increasing the length of the driving unit may be selectively performed. In the pressure adding operation a6, the driving part may be rotated in a direction, in which the fixing part provided in the form of a bolt and the coupling part provided in the form of a nut are fastened to each other, and to the contrary, in the pressure reducing operation a5, the driving part may be rotated in a direction, in which the fixing part and the coupling part are released from each other.

After the control operations a5 and a6, the pressure identifying operation a7 may be performed.

In the pressure identifying operation a7, an operation of identifying whether the difference between a measured pressure Pt and a preset initial pressure P0 is within a suitable range based on the pressure measured, determined or acquired by the pressure acquisition unit 52 may be performed. In the pressure identifying operation a7, it may be determined whether it is necessary to calibrate (readjust) the constraining pressure again through a preset pressure indicator value K2. K2 may differ depending on the state of charge (SOC) of the battery. In some embodiments, K2 may be 0.05.

When a ratio of the difference value between the measured pressure Pt and the preset initial pressure P0 to the initial pressure is less than the preset pressure indicator value

$$K 2 ( \vert \frac{Pt - P 0}{P 0} \vert < {K}_{2} ) ,$$

the thickness measuring operation a1 may be performed again, and to the contrary, when the ratio of the difference value between the measured pressure Pt and the preset initial pressure P0 to the initial pressure is the preset pressure indicator value K2 or more, the constraining pressure control determining operation a3 is performed again to repeat the process of readjusting the constraining pressure.

In all processes of charging and discharging the all-solid-state battery, such as charging, using, and leaving behind the all-solid-state battery, the sequential processes from the thickness measuring operation a1 to the pressure identifying operation a7 may be repeated as described above, and thus, the constraining pressure of the all-solid-state battery may be maintained within a suitable numerical range.

The all-solid-state battery assembly according to an exemplary embodiment of the present disclosure may control the constraining pressure of the all-solid-state battery.

The all-solid-state battery assembly according to an exemplary embodiment of the present disclosure may measure, determine or acquire the thickness displacement and the pressure of the all-solid-state battery in real time, and may control the constraining pressure based on the measured, determined or acquired data.

In addition, effects that may be easily predicted by a person skilled in the art may be shown from the configurations according to the embodiments of the present disclosure.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. An all-solid-state battery assembly comprising:
an all-solid-state battery comprising a plurality of electrode layers and a plurality of solid-electrolyte layers laminated in a lamination direction;
a housing accommodating the all-solid-state battery;
a pressure adjusting part configured to adjust a pressure applied to the all-solid-state battery; and
a displacement acquisition unit configured to measure, determine or acquire a change in a thickness of the all-solid-state battery in the lamination direction.

2. The all-solid-state battery assembly of claim 1, wherein the pressure adjusting part comprises:
a constraining pad disposed in an interior of the housing and overlapping the all-solid-state battery in the lamination direction to press the all-solid-state battery; and
at least one driving unit disposed to be spaced apart from the all-solid-state battery and connected to the constraining pad to control a pressure applied to the all-solid-state battery by the constraining pad.

3. The all-solid-state battery assembly of claim 2, wherein the displacement acquisition unit is configured to contact one surface of the all-solid-state battery on an outermost side in the lamination direction and measures, determines or acquire the change in the thickness of the all-solid-state battery by measuring a distance, by which the one surface of the all-solid-state battery is moved along the lamination direction.

4. The all-solid-state battery assembly of claim 2, wherein the displacement acquisition unit is configured to contact one surface of the all-solid-state battery, which contacts the constraining pad.

5. The all-solid-state battery assembly of claim 2, wherein the displacement acquisition unit is configured to pass through the constraining pad to contact one surface of the all-solid-state battery, which contacts the constraining pad.

6. The all-solid-state battery assembly of claim 1, wherein the displacement acquisition unit comprises a first displacement acquisition unit and a second displacement acquisition unit disposed to be spaced apart from each other.

7. The all-solid-state battery assembly of claim 1, wherein the displacement acquisition unit comprises a first displacement acquisition unit and a second displacement acquisition unit located at the same distance from a central axis passing through a center of the all-solid-state battery in the lamination direction.

8. The all-solid-state battery assembly of claim 2, wherein the driving unit is configured to adjust a distance between one inner surface of the housing, which overlaps the all-solid-state battery in the lamination direction, and is configured to support the all-solid-state battery when being pressed by the constraining pad, and the constraining pad disposed to be spaced apart from the one inner surface in the lamination direction.

9. The all-solid-state battery assembly of claim 2, wherein the constraining pad is configured to overlap the all-solid-state battery in the lamination direction, and is disposed to be spaced apart from one inner surface of the housing, which is configured to support the all-solid-state battery when being pressed by the constraining pad, in the lamination direction.

10. The all-solid-state battery assembly of claim 2, wherein the driving unit is located between one inner surface of the housing, which is configured to support the all-solid-state battery when being pressed by the constraining pad, and the constraining pad, to control a pressure applied to the all-solid-state battery by the constraining pad through a change in a length thereof in a state, in which the one inner surface and the constraining pad are connected to each other.

11. The all-solid-state battery assembly of claim 2, wherein the at least one driving unit is a pair of driving units, and
wherein the pair of driving units are provided on one side and an opposite side of the all-solid-state battery.

12. The all-solid-state battery assembly of claim 2, wherein the driving unit comprises:
a fixing part protruding from one inner surface configured to support the all-solid-state battery when being pressed by the constraining pad, in the lamination direction;
a coupling part coupled to the fixing part to be moved relative to the fixing part in the lamination direction; and
a driving part connected to the coupling part, and configured to drive the coupling part such that the coupling part is moved with respect to the fixing part.

13. The all-solid-state battery assembly of claim 2, further comprising:
a pressure acquisition unit overlapping the all-solid-state battery in the lamination direction, and configured to measure, determine or acquire a pressure applied to the all-solid-state battery in the lamination direction.

14. The all-solid-state battery assembly of claim 2, further comprising:
a pressure acquisition unit disposed between one inner surface of the housing, which is configured to support the all-solid-state battery when being pressed by the constraining pad, and the all-solid-state battery.

15. The all-solid-state battery assembly of claim 2, further comprising:
a processor configured to control driving of the driving unit based on a change in the thickness of the all-solid-state battery in the lamination direction, which is measured, determined or acquired by the displacement acquisition unit.

16. The all-solid-state battery assembly of claim 15, wherein the processor is configured to control driving of the driving unit based on a difference value between a preset initial thickness of the all-solid-state battery and the measured thickness of the all-solid-state battery.

17. The all-solid-state battery assembly of claim 16, wherein the processor is configured to control a driving direction of the driving unit such that a pressure applied to the all-solid-state battery decreases when the ratio of the difference value to the initial thickness is more than the preset indicator value and the measured thickness of the all-solid-state battery is smaller than the initial thickness.

18. The all-solid-state battery assembly of claim 16, wherein the processor is configured to control a driving direction of the driving unit such that a pressure applied to the all-solid-state battery increases when the ratio of the difference value to the initial thickness is more than the preset indicator value and the measured thickness of the all-solid-state battery is larger than the initial thickness.

19. The all-solid-state battery assembly of claim 13, further comprising:
a processor configured to drive the driving unit based on the change in the thickness of the all-solid-state battery in the lamination direction, which is measured, determined or acquired by the displacement acquisition unit, and the pressure of the all-solid-state battery, which is measured, determined or acquired by the pressure acquisition unit.

20. The all-solid-state battery assembly of claim 19, wherein the processor is configured to control driving of the driving unit based on a differenced value between a preset initial thickness of the all-solid-state battery and the measured thickness of the all-solid-state battery, and readjust the driving of the driving unit by identifying a pressure of the all-solid-state battery caused by the driving of the driving unit.
